(19) United States
(12) Patent Application Publication
(10) Pub. No.: US 2005/0019022 A1
(43) Pub. Date: Jan. 27, 2005

(54) Computer system

(75) Inventor: Kyung-min Lee, Suwon City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/896,964

(22) Filed: Jul. 23, 2004

(30) Foreign Application Priority Data
Jul. 24, 2003 (KR) 2003-50907

(51) Int. Cl. H04N 5/781

(52) U.S. Cl. 386/125; 386/126

(57) ABSTRACT

A computer system including a display to display an image; an audio outputter to output a sound; a system main body to output audio and/or video signals to the audio outputter and the display, respectively; an optical disk drive to reproduce audio and/or video signals recorded in an optical disk; a drive reproducer to convert audio and/or video signals reproduced by the optical disk drive into audio and/or video signals that are processed by the audio outputter and the display, respectively, and to output the converted audio and/or video signals to the audio outputter and the display, respectively The computer system further includes an audio/video signal switch to allow the audio and/or video signals reproduced by the optical disk drive to be selectively transmitted to one of the system main body and the drive reproducer; a power supply to supply electric power to the system main body and the drive reproducer; and a power switching part to allow electric power to be selectively supplied to one of the system main body and the drive reproducer. Thus, the present invention provides a computer system via which an optical disk such as the DVD is played by an optical disk drive such the DVD drive without booting the system.

### CROSS-REFERENCE TO RELATED APPLICATIONS

This application claims the benefit of Korean Patent Application No. 2003-50907, filed Jul. 24, 2003, in the Korean Intellectual Property Office, the disclosure of which is incorporated herein by reference.

### BACKGROUND OF THE INVENTION

1. Field of the Invention

The present invention relates to a computer system, and more particularly, to a computer system in which an optical disk such as a digital versatile disk (DVD) is played via an optical disk drive such as a DVD drive without booting the system.

2. Description of the Related Art

Generally, an optical disk drive such as a compact disk (CD) drive or a DVD drive is used to play an optical disk including a video compact disk (VCD), a DVD, or the like in a multimedia computer system.

A DVD provides a storage capacity between 4.7 GB and 17 GB, which is sufficient to store a large amount of data of a moving picture, thus, DVD is used to store video/audio data to support a high quality picture and a sound of multiple channels. The DVD drive that plays the DVD is compatible with the CD so that the DVD drive can be substituted for a CD drive. The DVD stores video/audio data compressed by a video compression technique such as a moving picture experts group (MPEG)-2 video compression technique or an audio compression technique including the MPEG-2 and an AC-3 audio compression technique.

A conventional computer system installed with a DVD drive has an MPEG-2 CODEC (coder/decoder) progRAM that is based on the operating system or a card having a MPEG-2 decoder in a form of a chip so that the MPEG-2 CODEC progRAM or the card decodes video/audio signals reproduced by the DVD drive. The decoded video/audio signals are outputted to a monitor and a system through a video controller and audio controller, respectively.

However, the conventional computer system presents a problem because the computer system needs to be booted in order to play the DVD through the DVD drive. Thus, electric power is supplied to components that are not needed to play the DVD, thereby, causing unnecessary consumption of electric power, which presents a problem especially for portable computers with limited power supply. Moreover, if the computer system needs to be booted for the sole purpose of playing the DVD, the computer system has to go through unnecessary boot time.

### SUMMARY OF THE INVENTION

Accordingly, it is an aspect of the present invention to provide a computer system according to which an optical disk such as a DVD is played by an optical disk drive such as a DVD drive without booting the system.

The foregoing and/or other aspects of the present invention are also achieved by providing a computer system comprising: a display to display an image; an audio outputter to output a sound; a system main body to output audio and/or video signals to the audio outputter and the display, respectively; an optical disk drive to reproduce audio and/or video signals recorded in an optical disk; a drive reproducer to convert audio and/or video signals reproduced by the optical disk drive into audio and/or video signals that are processed by the audio outputter and the display, respectively, and to output the converted audio and/or video signals to the audio outputter and the display, respectively; an audio and/or video signal switch to allow the audio and/or video signals reproduced by the optical disk drive to be selectively transmitted to one of the system main body and the drive reproducer; a power supply to supply electric power to the system main body and the drive reproducer; and a power switching part to allow electric power from the power supply to be selectively supplied to one of the system main body and the drive reproducer.

Additional aspects and advantages of the invention will be set forth in part in the description which follows and, in part, will be obvious from the description, or may be learned by practice of the invention.

According to an aspect of the invention, the drive reproducer comprises: a signal divider to divide the audio and video signals reproduced by the optical disk drive into an audio signal and a video signal, and to output the audio signal and the video signal; a video signal processor to convert the video signal outputted from the signal divider into a signal that is displayed on the display; an audio signal processor to convert the audio signal outputted from the signal divider into a signal that is outputted by the audio outputter; and a controller to control the signal divider, the video signal processor, and the audio signal processor.

According to an aspect of the invention, the display supports a low voltage differential signaling (LVDS) interface, and the video signal processor comprises: a video decoder to decode the video signal outputted from the signal divider; and an LVDS encoder to convert the video signal decoded by the video decoder into an LVDS signal and to output the converted signal.

According to an aspect of the invention, the audio signal processor comprises: an audio decoder to decode an audio signal outputted from the signal divider; and a D/A converter to convert the audio signal decoded by the audio decoder into an analog signal.

According to another aspect of the invention, the power switching part comprises: a system power button to supply electric power from the power supply to the system main body therethrough; and a reproducer power button to supply electric power from the power supply to the optical disk drive and the drive reproducer therethrough.

According to an aspect of the invention, the power supply is provided to supply electric power to the display, and the power supply supplies electric power from the power supply to the display when the reproducer power button is turned on.

According to an aspect of the invention, the computer system further comprises a video switch to allow one of a video signal outputted from the system main body and a video signal outputted from the drive reproducer to be selectively transmitted to the display.

According to an aspect of the invention, the video switch is controlled to allow a video signal outputted from the drive reproducer to be transmitted to the display when the reproducer power button is turned on.

According to another aspect of the invention, the computer system further comprises: an audio switch to allow one of an audio signal outputted from the system main body and an audio signal outputted from the drive reproducer to be transmitted to the audio outputter.

According to another aspect of the invention, the audio switch is controlled to allow the audio signal outputted from the drive reproducer to be transmitted to the audio outputter when the reproducer power button is turned on.

According to an aspect of the invention, the computer system further comprises: a video switch to allow one of a video signal outputted from the system main body and a video signal outputted from the video signal processor to be selectively transmitted to the display, and the controller controls the video switch to transmit the video signal outputted from the video signal processor to the display when the audio and/or video signals are transmitted from the optical disk drive to the drive reproducer.

According to an aspect of the invention, the computer system further comprises: an audio switch to allow one of an audio signal outputted from the system main body and an audio signal outputted from the audio signal processor to be selectively transmitted to the audio outputter, and the controller controls the audio switch to transmit the audio signal outputted from the audio signal processor to the audio outputter when the audio and/or video signals are transmitted from the optical disk drive to the drive reproducer.

### BRIEF DESCRIPTION OF THE DRAWINGS

The above and/or other aspects and advantages of the invention will become apparent, and more readily appreciated from the following description of the preferred embodiments, taken in conjunction with accompanying drawings of which:

FIG. 1 is a schematic control block diagram of a computer system according to an aspect of the present invention;

FIG. 2 is a control block diagram of a computer system according to another aspect of the present invention;

FIG. 3 is a control block diagram of a computer system according to another aspect of the present invention; and

FIG. 4 is a control block diagram of a drive reproducer of the computer systems in FIGS. 2 and 3 according to various aspects of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout.

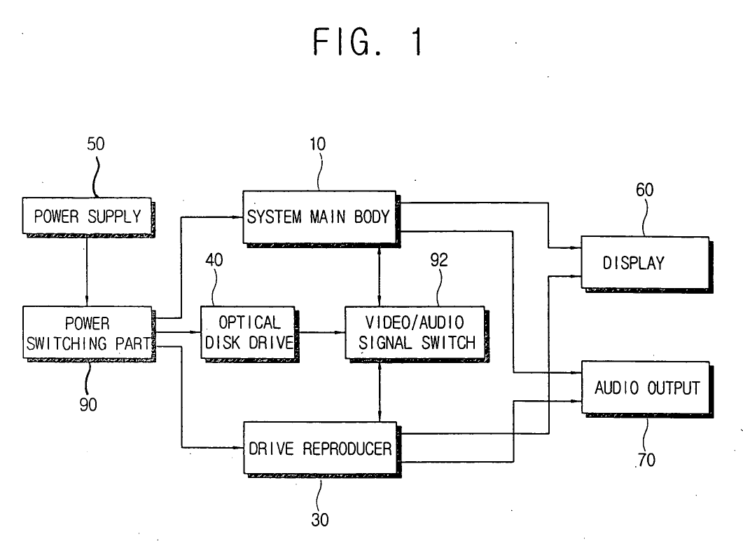

As shown in FIG. 1, a computer system according to an aspect of the present invention comprises: a display 60 to display an image; an audio outputter 70 to output a sound; a system main body 10 to output audio and/or video signals to the audio outputter 70 and the display 60, respectively; an optical disk drive 40 to reproduce audio and/or video signals recorded in an optical disk; a drive reproducer 30 to convert the audio and/or video signals reproduced by the optical disk drive 40 into the audio and/or video signals that are processed by the audio outputter 70 and the display 60, and to output the converted audio and/or video signals to the audio outputter 70 and the display 60, respectively; an audio/video signal switch 92 to allow the audio and/or video signals reproduced by the optical disk drive 40 to be selectively transmitted to one of the system main body 10 and the drive reproducer 30; a power supply 50 to supply electric power to the system main body 10 and the drive reproducer 30; and a power switching part 90 to allow electric power from the power supply 50 to be selectively supplied to one of the system main body 10 and the drive reproducer 30.

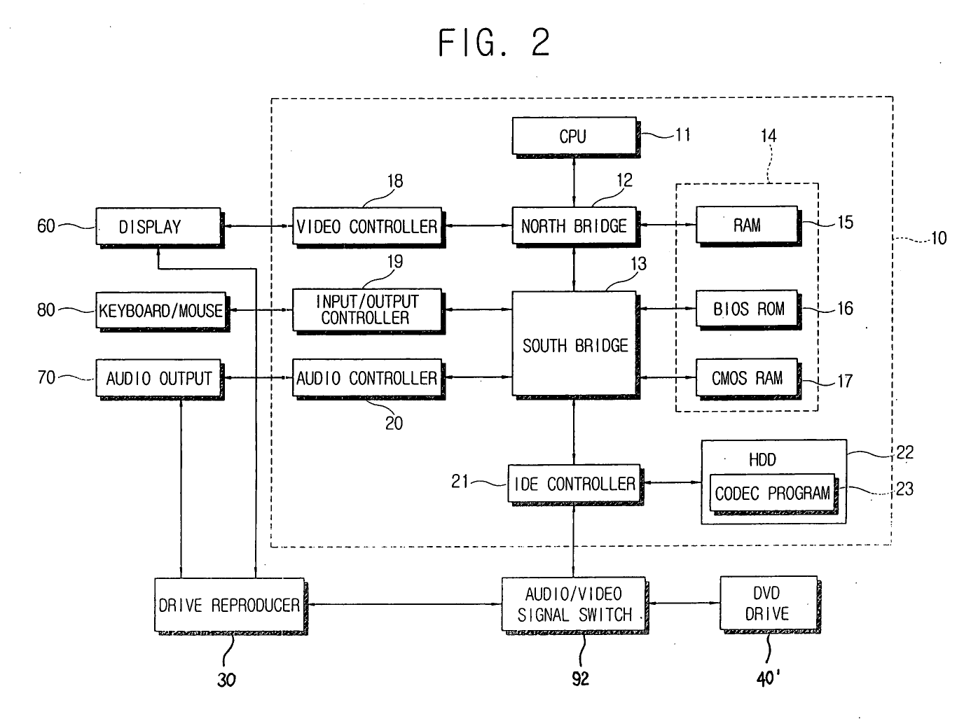

FIG. 2 is a control block diagram of a computer system according to an aspect of the present invention. Hereinbelow, the computer system according to an aspect of the present invention is described in more detail with reference to FIG. 2. A DVD is taken as an example of an optical disk and a DVD drive 40′ is taken as an example of the optical disk drive 40.

The system main body 10 comprises: a CPU 11 (central processing unit), a memory 14, a video controller 18 connected to the display 60 to transmit a video signal to the display 60, an input/output controller 19 to process a signal inputted by input devices, such as a keyboard, a mouse 80 or other similar and/or equivalent input devices, an audio controller 20 connected to the audio outputter 70 to transmit an audio signal to the audio outputter 70, a north bridge 12 and a south bridge 13.

The memory 14 comprises: a RAM 15 (random access memory) as a nonvolatile memory, a BIOS (basic input/output system), a ROM (read only memory) 16 to store the BIOS therein and a CMOS (complementary metal oxide semiconductor) RAM 17.

The north bridge 12 is a chipset provided to manage data exchanged between the CPU 11, the RAM 15 and the video controller 18, and the south bridge 13 is a chipset provided to manage data exchanged between the input/output controller 19, the audio controller 20, the BIOS ROM 16, and the CMOS RAM 17.

According to another aspect of the invention, the system main body 10 comprises: an integrated drive electronics (IDE) controller 21 connected to the south bridge 13 to manage a hard disk drive (HDD) 22 and the DVD drive 40′. According to another aspect of the present invention, in the hard disk drive 22, a CODEC progRAM 23 is installed to process the video/audio signals reproduced by the DVD drive 40′.

The power supply 50 according to another aspect of the present invention supplies electric power to the system main body 10 and the drive reproducer 30. According to an aspect of the present invention, if the computer system is a portable computer, the power supply 50 may supply electric power to the display 60.

The power switching part 90 allows electric power from the power supply 50 to be selectively supplied to one of the system main body 10 and the drive reproducer 30. Here, the power switching part 90 according to an aspect of the present invention comprises: a system power button used to supply electric power from the power supply 50 to the system main body 10 therethrough, and a reproducer power button used to supply electric power from the power supply 50 to the DVD drive 40′ and the drive reproducer 30 therethrough. When a user turns the system power button on, electric power is supplied to the system main body 10, thereby booting the computer system. When a user turns the reproducer power button on, electric power from the power supply 50 is supplied to the DVD drive 40′ and the drive reproducer 30, i.e., the components required to reproduce the DVD drive 40′ without booting the computer system. Thus, the DVD is played without booting the whole computer system, thereby eliminating the time required to boot the system when the DVD is played. Further, electric power is not supplied to components that are not required to play the DVD, thereby, saving electric power.

In case of a portable computer, if the display 60 according to an aspect of the present invention uses the same power supply as that of the system main body 10, electric power may be supplied to the display 60 from the power supply 50 when electric power is supplied to the DVD drive 40′ and the drive reproducer 30, i.e., the reproducer power button is turned on. Thus, an image is displayed on the display 60 when the DVD is played.

The drive reproducer 30 according to an aspect of the present invention divides the video and audio signals reproduced by the DVD drive 40′ into a video signal that the display 60 can display and an audio signal that the audio outputter 70 can output, and converts the divided signals into a video signal that the display 60 can display and an audio signal that the audio outputter 70 can output, respectively. Then, the drive producer 30 outputs the converted video/audio signals to the display 60 and the audio outputter 70, respectively. A detailed description of the drive reproducer 30 is given in subsequent paragraphs.

The video/audio signal switch 92 allows the video and/or audio signals reproduced and outputted by the DVD drive 40′ to be selectively transmitted to one of the IDE controller 21 of the system main body 10 and the drive reproducer 30. Accordingly, the video/audio signal switch 92 is controlled so that when a user turns the system power button on, the video/audio signal switch 92 allows the video/audio signals reproduced and outputted by the DVD drive 40′ to be transmitted to the system main body 10, and when a user turns the reproducer power button on, the video/audio signal switch 92 allows the video/audio signals reproduced and outputted by the DVD drive 40′ to be transmitted to the drive reproducer 30. For example, if the user turns on the system power button or the reproducer power button, a predetermined control signal is transmitted to the video/audio signal switch 92 and the video/audio signal switch 92 is operated corresponding to the supplied control signal.

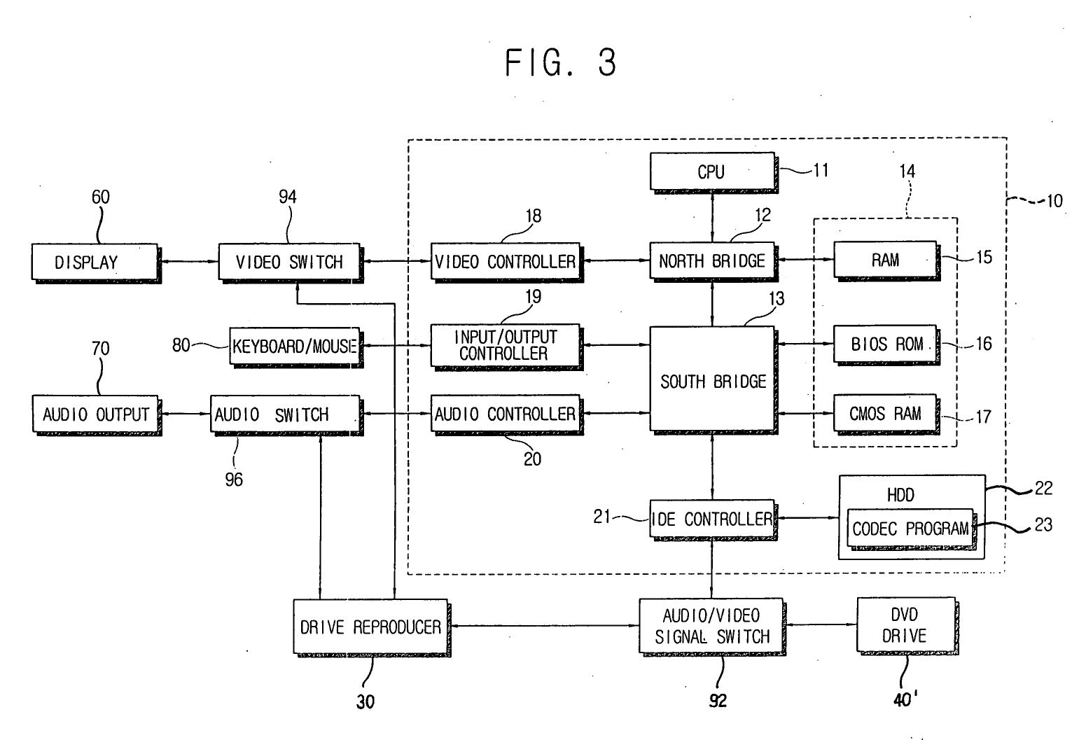

FIG. 3 is a control block diagram of a computer system according to another aspect of the present invention. As shown, the computer system comprises a video switch 94 to allow one of a video signal outputted from the system main body 10 and a video signal outputted from the drive reproducer 30 to be selectively displayed on the display unit 60. Further, the computer system comprises an audio switch 96 to allow one of an audio signal outputted from the system main body 10 and an audio signal outputted from the drive reproducer 30 to be selectively transmitted to the audio outputter 70.

The video switch 94 is switched to allow one of a video signal outputted from the video controller 18 of the system main body 10 and a video signal outputted from the drive reproducer 30 to be displayed on the display 60. Accordingly, the video signal switch 94 is controlled such that when a user turns the system power button on, the video signal switch 94 allows the video signal outputted from the video controller 18 of the system main body 10 to be transmitted to the video display 60 and when a user turns the reproducer power button on, the video signal switch 94 allows the video signal outputted by the drive reproducer 30 to be transmitted to the display 60. For example, if the user turns on the system power button or the reproducer power button, a predetermined control signal is supplied to the video signal switch 94, and the video signal switch 94 is operated in response to the supplied control signal.

The audio switch 96 is switched to allow one of an audio signal outputted from the audio controller 20 of the system main body 10 and an audio signal outputted from the drive reproducer 30 to be transmitted to the audio outputter 70. Accordingly, the audio signal switch 96 is controlled such that when a user turns the system power button on, the audio signal switch 96 allows the audio signal outputted from the audio controller 20 of the system main body 10 to be transmitted to the audio outputter 70, and when the user turns the reproducer power button on, the audio signal switch 96 allows the audio signal outputted from the drive reproducer 30 to be transmitted to the audio outputter 70.

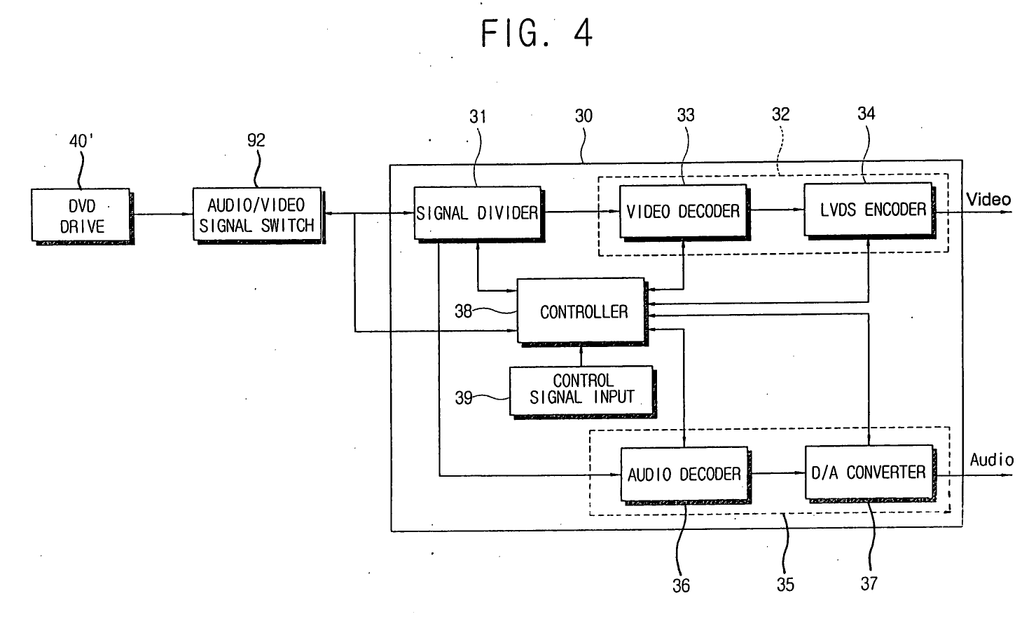

FIG. 4 is a control block diagram of the drive reproducer 30 according to an aspect of the present invention. As shown, the drive reproducer 30 comprises: a signal divider 31 to divide the video/audio signals reproduced by the optical disk drive 40 into a video signal and an audio signal, and to output the audio signal and the video signal; a video signal processor 32 to convert the video signal outputted from the signal divider 31 into a signal that is displayed on the display 60; an audio signal processor 32 to convert the audio signal outputted from the signal divider 31 into a signal that is outputted by the audio outputter 70; and a controller 38 to control the signal divider 31, the video signal processor 32, and the audio signal processor 35.

The video signal processor 32 according to another aspect of the present invention comprises: a video decoder 33, such as a MPEG-2 decoder to decode a video signal outputted from the signal divider 31 and an LVDS (low voltage differential signaling) encoder 34 to convert a video signal decoded by the video decoder 33 into an LVDS signal and to output the converted video signal. Here, an LVDS is a standard of an interface between the computer main body and a liquid crystal display (LCD). Thus, the display 60 is provided to support the LVDS interface.

The audio signal processor 35 according to an aspect of the present invention comprises: an audio decoder 36, such as the MPEG-2 decoder and/or the AC-3 decoder to decode an audio signal outputted from the signal divider 31, and a D/A converter 37 to convert an audio signal decoded by the audio decoder 36 into an analog signal. The audio signal converted into the analog signal by the D/A converter 37 is transmitted to the audio outputter 70 and outputted.

The drive reproducer 30 according to another aspect of the present invention comprises: a control signal inputter 39 to input a control signal in the controller 38. The control signal inputter 39 is provided to input a plurality of control signals required to commonly operate the DVD drive 40′, such as a play signal input by the user to play the DVD. According to an aspect of the present invention, the control signal inputter 39 may be provided as a plurality of operation buttons installed to a front surface of the DVD drive 40′ or as a remote controller.

Accordingly, when the reproducer power button is turned on, the video switch 94 and the audio switch 96 are controlled to output the video signal and the audio signal outputted from the drive reproducer 30 to the display 60 and the audio outputter 70, respectively. When the reproducer power button is turned on and electric power is supplied to the drive reproducer 30, the controller 38 of the drive reproducer 30 may control the video switch 94 and the audio switch 96, so that the video signal and the audio signal outputted from the drive reproducer 30 are outputted to the display 60 and the audio outputter 70, respectively.

Further, the video signal processor 32 comprises the video decoder 33 and the LVDS encoder 34. However, the video signal processor 32 may comprise only the video decoder 32 depending on the interface the display 60 supports.

Further, the audio signal processor 35 comprises the audio decoder 36 and the D/A converter 37. However, if the audio outputter 70 is a speaker that can process an inputted digital signal, the audio signal processor 35 may comprise only the audio decoder 36 with the exception of the D/A converter 37.

Accordingly, an aspect of the present invention provides a computer system that comprises: an optical disk drive to reproduce audio and/or video signals recorded in an optical disk; a drive reproducer to convert audio and/or video signals reproduced by the optical disk drive into audio and/or video signals that are processed by the display and the audio outputter and to output the converted audio and/or video signals to the audio outputter and the display, respectively; an audio/video signal switch to allow the audio/video signals reproduced by the optical disk drive to be selectively transmitted to one of the system main body and the drive reproducer; a power supply to supply electric power to the system main body and the drive reproducer; and a power switching part to allow electric power from the power supply to be selectively supplied to one of the system main body and the drive reproducer so that the optical disk such as the DVD is played by the optical disk drive such as the DVD drive without booting the system. Thus, if only the optical disk is desired to be played, time to boot the system is eliminated and unnecessary electric power is not consumed.

As described above, the present invention provides a computer system according to which an optical disk, such as a DVD, is played by an optical disk drive, such as a DVD drive without booting the entire system.

Although a few embodiments of the present invention have been shown and described, it will be appreciated by those skilled in the art that changes may be made in these embodiments without departing from the principles and spirit of the invention, the scope of which is defined in the appended.

1. A computer system, comprising:
a display to display an image;
an audio outputter to output a sound;
a system main body to output audio and/or video signals to the audio outputter and the display, respectively;
an optical disk drive to reproduce audio and/or video signal recorded in an optical disk;
a drive reproducer to convert audio and/or video signals reproduced by the optical disk drive into audio and/or video signals that are processed by the audio outputter and the display, respectively, and to output the converted audio/video signals to the audio outputter and the display, respectively;
an audio and/or video signals switch to allow the audio and/or video signals reproduced by the optical disk drive to be selectively transmitted to one of the system main body and the drive reproducer;
a power supply to supply electric power to the system main body and the drive reproducer; and
a power switching part to allow electric power from the power supply to be selectively supplied to one of the system main body and the drive reproducer.

2. The computer system according to claim 1, wherein the drive reproducer comprises:
a signal divider to divide the audio and video signals reproduced by the optical disk drive into an audio signal and a video signal, respectively, and to output the audio signal and the video signal;
a video signal processor to convert the video signal outputted from the signal divider into a signal that is displayed on the display;
an audio signal processor to convert the audio signal outputted from the signal divider into a signal that is outputted by the audio outputter; and
a controller to control the signal divider, the video signal processor, and the audio signal processor.

3. The computer system according to claim 2, wherein the display supports an LVDS interface, and
the video signal processor comprises:
a video decoder to decode the video signal outputted from the signal divider; and
an LVDS encoder to convert the video signal decoded by the video decoder into an LVDS signal, and to output the converted signal.

4. The computer system according to claim 2, wherein the audio signal processor comprises:
an audio decoder to decode an audio signal outputted from the signal divider; and
a D/A converter to convert the audio signal decoded by the audio decoder into an analog signal.

5. The computer system according to claim 1, wherein the power switching part comprises:
a system power button to supply electric power from the power supply to the system main body; and
a reproducer power button to supply electric power from the power supply to the optical disk drive and the drive reproducer.

6. The computer system according to claim 5, wherein
the power supply is provided to supply electric power to the display, and
the power supply supplies electric power to the display when the reproducer power button is turned on.

7. The computer system according to claim 5, further comprising:
a video switch to allow one of a video signal outputted from the system main body and a video signal outputted from the drive reproducer to be selectively transmitted to the display.

8. The computer system according to claim 7, wherein the video switch is controlled to allow a video signal outputted from the drive reproducer to be transmitted to the display when the reproducer power button is turned on.

9. The computer system according to claim 5, further comprising:
an audio switch to allow one of an audio signal outputted from the system main body and an audio signal outputted from the drive reproducer to be transmitted to the audio outputter.

10. The computer system according to claim 9, wherein the audio switch is controlled to allow the audio signal outputted from the drive reproducer to be transmitted to the audio outputter when the reproducer power button is turned on.

11. The computer system according to claim 2, further comprising:
a video switch to allow one of a video signal outputted from the system main body and a video signal outputted from the video signal processor to be selectively transmitted to the display, wherein the controller controls the video switch to transmit the video signal outputted from the video signal processor to the display when the audio and/or video signal are transmitted from the optical disk drive to the drive reproducer.

12. The computer system according to claim 2, further comprising:
an audio switch to allow one of an audio signal outputted from the system main body and an audio signal outputted from the audio signal processor to be selectively transmitted to the audio outputter, wherein the controller controls the audio switch to transmit the audio signal outputted from the audio signal processor to the audio outputter when the audio and/or video signal are transmitted from the optical disk drive to the drive reproducer.

13. The computer system according to claim 1, wherein the system main body comprises:
a video controller connected to the display, to transmit the video signal to the display; and
an audio controller connected to the audio outputter, to transmit the audio signal to the audio outputter.

14. The computer system according to claim 5, wherein
electric power is supplied to the system main body when the system power button is turned on, and
electric power is selectively supplied to the drive reproducer and the optical disk drive when the reproducer power button is turned on.

15. The computer system according to claim 14, wherein electric power is also supplied to the display when the reproducer power button is turned on.

16. A computer system having a display, comprising:
an optical disk drive to reproduce recorded audio and/or video signals;
an audio output unit to output a sound;
a drive reproducer to convert audio and/or video signals reproduced by the optical disk drive into audio and/or video signals to be processed by the display and the audio output unit, and to output the converted audio/video signals to the audio outputter and the display, respectively;
an audio and/or video signal switch to selectively transmit the audio and/or video signals reproduced by the optical disk; and
a power switching part to allow electric power to be selectively supplied to the drive reproducer and the optical disk drive so that an optical disk is played by the optical disk drive without booting the computer system.

17. The computer system according to claim 16, wherein the computer system is a portable computer.

18. The computer system according to claim 17, wherein the drive reproducer comprises:
a signal divider to divide the audio and video signals reproduced by the optical disk drive into an audio signal and a video signal, respectively, and to output the audio signal and the video signal;
a video signal processor to convert the video signal outputted from the signal divider into a signal that is displayed on the display;
an audio signal processor to convert the audio signal outputted from the signal divider into a signal that is outputted by the audio output unit; and
a controller to control the signal divider, the video signal processor, and the audio signal processor.

19. The computer system according to claim 18, further comprising:
a control signal inputter to allow input of a plurality of control signals into the controller.

20. The computer system according to claim 17, wherein the power switching part comprises:
a reproducer power button to selectively supply electric power to the optical disk drive and the drive reproducer when a user turns the reproducer power button on.
